(19) United States
(12) Patent Application Publication
(10) Pub. No.: US 2012/0188472 A1
(43) Pub. Date: Jul. 26, 2012

(54) Monolithic Liquid Crystal Shutter Glasses

(76) Inventor: Hsiao Peng Sheng, New Taipei (TW)

(21) Appl. No.: 13/098,295

(22) Filed: Apr. 29, 2011

(30) Foreign Application Priority Data
Jan. 26, 2011 (TW) 100102760

(51) Int. Cl. G02F 1/1335

(52) U.S. Cl. 349/13

(57) ABSTRACT

Monolithic LCS glasses, which comprising: lens module available with two transparent lens in parallel; these two transparent lens consist of the first and second visual areas; a first and a second LCS layer are interconnected and arranged between two transparent lens; a first and a second drive electrode is arranged separately onto these two transparent lens adjacent to the first and second LCS layers; a frame used to support the lens module, comprising of a built-in control circuit; said control circuit is electrically connected with said first and second drive electrodes, and used to control non-synchronized polarization of LCS in the first and second LCS layers via two control signals, such that the first and second visual areas could shield or penetrate the incident light. In the present invention, a two-disc LCS glasses is simplified into a monolithic one, which features simple assembly, lower cost and ease of marketing.

### BACKGROUND OF INVENTION

1. Field of the Invention

The present invention relates generally to a liquid crystal shu (LCS) glasses, and more particularly to a monolithic LCS glasses.

2. Description of Related Art

The general public could enjoy stimulating programs as three dimensional (3D) movies and TVs become more popular; however, auxiliary tools, such as: 3D glasses, must be provided to sense 3D visual effects. Currently, 3D glasses are categorized into: red/blue filter glasses, polarizing glasses (referred collectively to as passive 3D glasses), and shutter glasses (referred collectively to as active 3D glasses), which are also called as LCS glasses.

As disclosed in Taiwan patent No. M390467, existing LCS glasses generally comprises a frame, two conducting lens and a control circuit device, of which the conducting lens are built into the lens hole of the frame; the control circuit device could control the power-on/-off for these two conducting lens at different frequencies, enabling the conducting lens to be visualized during power-on or darkened during power-off in such case, the users will generate a stereoscopic vision if left and right images are switched simultaneously in tune with the varying frequency.

As also disclosed in Taiwan patent No. 507875, the LCS glasses comprises a frame and two electronic LCS lens, of which the optical structure of the electronic LCS lens is composed of two polarizers, two transparent conducting glasses and a LCS molecule layer; under the driving of external voltage, these two electronic LCS lens could shield or penetrate the incoming natural light.

Thus, LCS glasses in existing technology is designed into a two-disc pattern, but the intermediate frame will partially block off the sight; moreover, LCS set in the same LCS glasses are not manufactured simultaneously, leading to different performance; and the complex assembly and high cost of two-disc LCS glasses make it difficult for widespread applications.

To address the aforementioned problems, as disclosed in US patent No. US20020163600, a monolithic LCS glasses structurally comprises an LCS unit electrically connected with a controller; a layer of polarizing film is coated onto one surface of the LCS unit, and a divided polarizing film coated onto the other surface of the LCS unit; the polarizing axles of the divided polarizing film run in perpendicular; LCS in the LCS unit are polarized through the conduction or disconnection of the LC unit, but the left and right lens could only shield or penetrate light alternatively, since this is not controlled separately by independent controllers; in such case, it cannot be applied to existing imaging units “that improve residual imaging technology by changing the switching cycle of LCS glasses”.

### SUMMARY OF THE INVENTION

The objective of the present invention is to provide a monolithic LCS glasses that can be widely promoted in the market and also used to some imaging units with improved residual imaging technology, due to its advantages including: lower defect, simple assembly and lower cost.

The present invention is implemented through the following technology schemes:

A monolithic LCS glasses, comprising:

lens module, available with two transparent lens in parallel; said two transparent lens consist of a first and a second visual area in relation to the left and right eyes of the user; a first and a second LCS layer are arranged between two transparent lens correspondingly to the first and second visual areas; said first LCS layer is connected with said second LCS layer; a first and a second drive electrode is arranged separately onto these two transparent lens adjacent to the first and second LCS layers;

a frame, used to support the lens module; said frame comprises of a built-in control circuit; said control circuit is electrically connected with said first and second drive electrodes, and used to control non-synchronized polarization of LCS in the first and second LCS layers via two control signals, such that the first and second visual areas could shield or penetrate the incident light.

Of which, a polarizing film is set separately onto the external surface of these two transparent lens for covering said first and second visual areas.

Of which, at least a packaging material is used to seal said first/second. LCS layers and said first/second drive electrodes between said two transparent lens.

Of which, there is a gap between the first and second drive electrodes.

Of which, said first and second visual areas is separately provided with a light-transmittance cycle via two control signals output by the control circuit, and the light-transmittance cycles are not superimposed.

Of which, a cut-off cycle enabling to shield simultaneously the incident light by the first and second visual areas is included between the light-transmittance cycles of said first and second visual areas.

Of which, said control circuit is electrically connected with a receiver set onto said frame.

Of which, said receiver is used to receive synchro image signals transmitted by the transmitter; said transmitter is electrically connected with the imaging device.

Of which, said control circuit is electrically connected with the transmission line of said transmitter, so as to receive synchro image signals transmitted by the transmitter; said transmitter is electrically connected with said imaging device.

Of which, said control circuit allows to decide the output sequence of the control signals depending on said synchro image signals.

Of which, said imaging device refers to a TV set, display or projector.

Efficacies of the present invention: the monolithic LCS glasses of the present invention comprises: lens module, available with two transparent lens in parallel; said two transparent lens consist of a first and a second visual area in relation to the left and right eyes of the user; a first and a second LCS layer are arranged between two transparent lens correspondingly to the first and second visual areas; said first LCS layer is connected with said second LCS layer; a first and a second drive electrode is arranged separately onto these two transparent lens adjacent to the first and second LCS layers; a frame, used to support the lens module; said frame comprises of a built-in control circuit; said control circuit is electrically connected with said first and second drive electrodes, and used to control non-synchronized polarization of LCS in the first and second LCS layers via two control signals, such that the first and second visual areas could shield or penetrate the incident light. As compared with prior art, said two transparent lens of the monolithic LCS glasses of the present invention consist of a first and a second visual area in relation to the left and right eyes of the user, such that the users could have a wider visual angle, and also eliminate the complex assembly to enable more accurate light-transmittance control by applying to the imaging device with improved residual imaging technology.

### BRIEF DESCRIPTION OF THE DRAWINGS

The above is a detailed description of the present invention based on a typical preferred embodiment. However, it should be appreciated that a variety of embodiments and various modifications can be made by those skilled in the art without too much efforts.

FIG. 1: a sectional view of lens module of monolithic LCS glasses of the present invention.

FIG. 2: a structural view of monolithic LCS glasses of the present invention.

FIG. 3: a process flow diagram of the control circuit of monolithic LCS glasses of the present invention.

### DETAILED DESCRIPTION OF THE INVENTION

The present invention is further described based on the following examples.

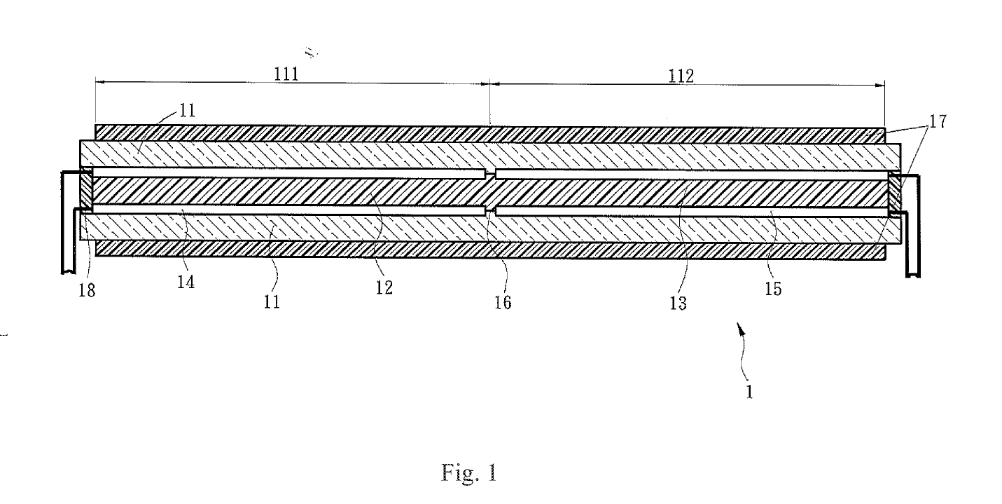

The monolithic LCS glasses of the present invention is illustrated in FIG. 1, wherein it comprising: a lens module 1, comprising of two transparent lens 11 in parallel, a first drive electrode 14, a second drive electrode 15, a first LCS layer 12 and a second LCS layer 13. Said two transparent lens 11 consist of a first and a second visual area 111, 112 in relation to the left and right eyes of the user; the first and second visual area 111, 112 are close to each other, and a polarizing film 17 is set separately onto these two transparent lens 11 for covering said first and second visual areas 111, 112. A first and a second LCS layer 12, 13 are arranged between two transparent lens 11 correspondingly to the first and second visual areas 111, 112; the first LCS layer 12 is connected with the second LCS layer 13.

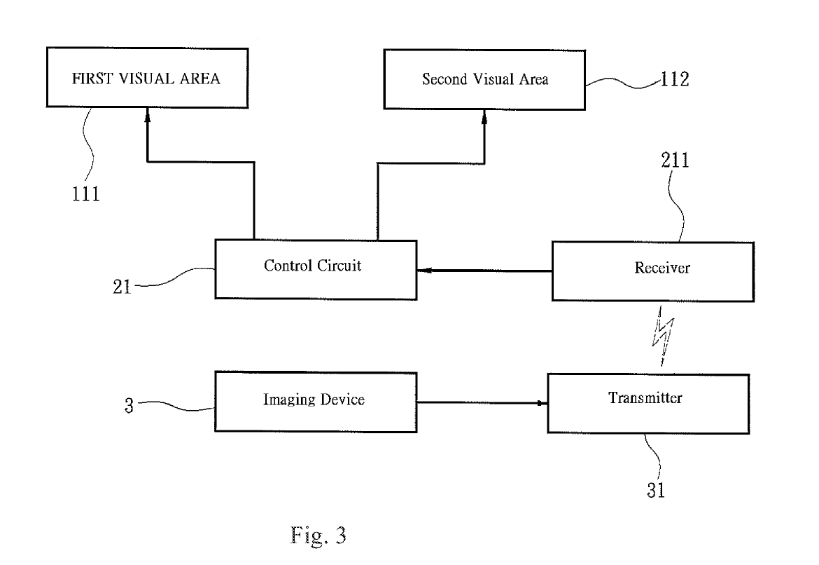

A first and a second drive electrode 14, 15 is arranged separately onto these two transparent lens 11 adjacent to the first and second LCS layers 12, 13; of which, the first drive electrode 14 is set correspondingly to the first LCS layer 12, and the second drive electrode 15 set correspondingly to the second LCS layer 13. The first and second drive electrodes 14, 15 are electrically connected with the control circuit 21 (shown in FIG. 3). Of which, there is a gap 16 between the first and second drive electrodes 14, 15, so the first and second drive electrodes 14, 15 are not connected, but independently controlled by a control circuit 21. At least a packaging material 18 is used to seal said first/second LCS layers 12, 13 and said first/second drive electrodes 14, 15 between said two transparent lens 11.

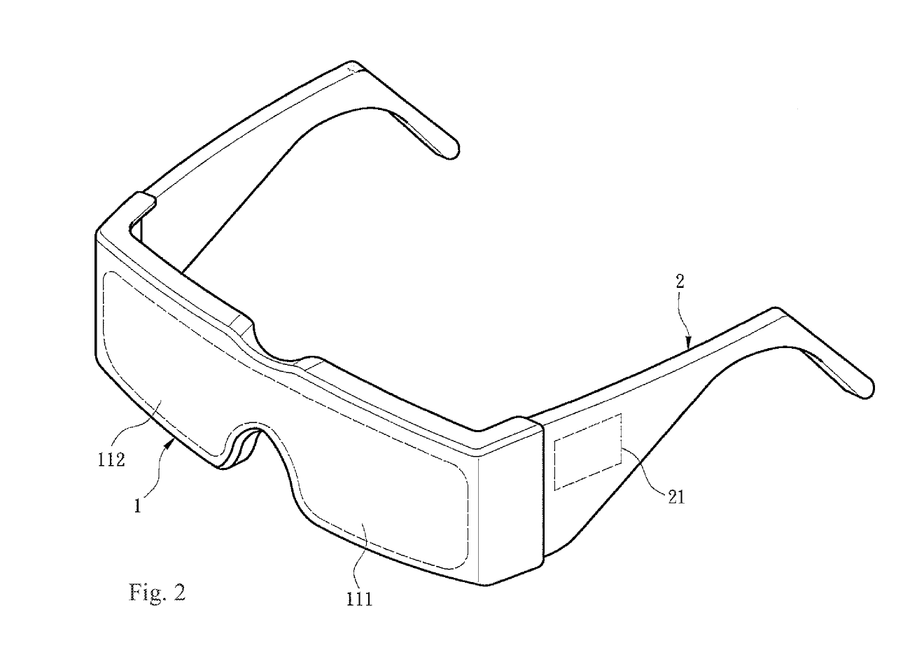

Referring to FIGS. 1, 2, the monolithic LCS glasses comprises a frame 2 used to support the lens module 1; of which, the lens module 1 comprises of two transparent lens 11 with the first and second visual areas 111, 112. The control circuit 21 is set onto the frame 2, and electrically connected with the first and second drive electrodes 14, 15; it is also used to control non-synchronized polarization of LCS in the first and second LCS layers 12, 13 via two control signals, such that the first and second visual areas 111, 112 could shield or penetrate the incident light.

Referring to FIG. 3, the control circuit 21 is electrically connected with a receiver 211 set onto said frame 2; said receiver 211 is used to receive synchro image signals transmitted by the transmitter 31; said transmitter 31 is electrically connected with the imaging; device 3. Said imaging device 3 refers to a TV set, display or projector.

Said control circuit 21 allows to decide the output sequence of the control signals depending on said synchro image signals; two control signals output by the control circuit 21 are separately used to drive the first and second drive electrodes 14, 15, enabling polarization of the first and second LCS layers 12, 13; the first and second visual areas 111, 112 is separately provided with a light-transmittance cycle, and the light-transmittance cycles are not superimposed. Moreover, a cut-off cycle enabling to shield simultaneously the incident light by the first and second visual areas 111, 112 is included between the light-transmittance cycles of the first and second visual areas 111, 112. Through alternative input to the first and second visual areas 111, 112 in the light-transmittance cycle and cut-off cycle, the first and second visual areas 111, 112 could not only shield and penetrate light alternatively, but also shield light simultaneously; this enables more accurate light-transmittance control and filtering of unnecessary light, while improving the flickering caused by ambient optical sources and reducing the influence of residual visual imaging.

The present invention is not limited to aforementioned preferred embodiment. Instead, said receiver 211 is electrically connected with the control circuit 21 and the transmission line of the transmitter 31; the transmission line is used to receive synchro image signals transmitted by the transmitter 31; said transmitter 31 is electrically connected with the imaging device 3.

To sum up, said two transparent lens 11 of the present invention consist of a first and a second visual area 111, 112 in relation to the left and right eyes of the user; so a monolithic LCS glasses can be designed to provide the users with a panoramic view; moreover, the design of monolithic lens could eliminate inconvenient assembly of common two-disc LCS glasses; as LCS layers of monolithic lens are interconnected, the first and second LCS layers 12, 13 are actually in the same LC layer; finally, the defective lens could be reduced as there is no difference between the first and second LC layers 12, 13; yet, as the LCS layers of existing two-disc lens are manufactured separately, the finished lens could be led to higher defect due to the difference of these two LCS layers. Conversely, monolithic LCS glasses could be manufactured in streamlined, procedures, thus saving the production cost and facilitating the marketing process.

On the other hand, monolithic stereo glasses in existing technology could not control independently left and right visual areas, nor change the switching cycle of these areas, so it cannot be applied to the imaging device with improved residual imaging technology. However, the present invention could control independently left and right visual areas, so it can be applied to some imaging devices with improved residual imaging technology.

Although the invention has been explained in relation to its preferred embodiment, it is to be understood that many other possible modifications and variations can be made without departing from the spirit and scope of the invention as hereinafter claimed.

1. A monolithic LCS glasses comprising:
a lens module, available with two transparent lens in parallel; said two transparent lens consist of a first and a second visual area in relation to the left and right eyes of the user; a first and a second LCS layer are arranged between two transparent lens correspondingly to the first and second visual areas; said first LCS layer is connected with said second LCS layer; a first and a second drive electrode is arranged separately onto these two transparent lens adjacent to the first and second LCS layers;
frame, used to support the lens module; said frame comprises of a built-in control circuit; said control circuit is electrically connected with said first and second drive electrodes, and used to control non-synchronized polarization of LCS in the first and second LCS layers via two control signals, such that the first and second visual areas could shield or penetrate the incident light.

2. The structure defined in claim 1, wherein a polarizing film is set separately onto the external surface of these two transparent lens for covering said first and second visual areas.

3. The structure defined in claim 1, wherein at least a packaging material is used to seal the first/second LC layers and first/second drive electrodes between said two transparent lens.

4. The structure defined in claim 1, wherein there is a gap between the first and second drive electrodes.

5. The structure defined in claim 1, wherein said first and second visual areas is separately provided with a light-transmittance cycle via two control signals output by the control circuit, and the light-transmittance cycles are not superimposed.

6. The structure defined in claim 5, wherein a cut-off cycle enabling to shield simultaneously the incident light by the first and second visual areas is included between the light-transmittance cycles of said first and second visual areas.

7. The structure defined in claim 1, wherein said control circuit is electrically connected with a receiver set onto said frame.

8. The structure defined in claim 7, wherein said receiver is used to receive synchro image signals transmitted by the transmitter; said transmitter is electrically connected with the imaging device.

9. The structure defined in claim 8, wherein said control circuit is electrically connected with the control circuit and the transmission line of said transmitter, so as to receive synchro image signals transmitted by the transmitter; said transmitter is electrically connected with said imaging device.

10. The structure defined in claim 8 or 9, wherein said control circuit allows to decide the output sequence of the control signals depending on said synchro image signals.

11. The structure defined in claim 8 or 9, wherein said imaging device refers to a TV set, display or projector.
